(19) United States
(12) Patent Application Publication
(10) Pub. No.: US 2011/0022774 A1
(43) Pub. Date: Jan. 27, 2011

(54) CACHE MEMORY CONTROL METHOD, AND INFORMATION STORAGE DEVICE COMPRISING CACHE MEMORY

(75) Inventors: Kazuya TAKADA, Kodaira-shi (JP); Kenji YOSHIDA, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/784,159

(22) Filed: May 20, 2010

(30) Foreign Application Priority Data
Jul. 22, 2009 (JP) 2009-171373

(51) Int. Cl. G06F 12/08; G06F 12/00

(52) U.S. Cl. 711/3; 711/E12.001; 711/E12.017

(57) ABSTRACT

According to a cache memory control method of an embodiment, a data write position in a segment of a cache memory is changed to an address to which a lower bit of a logical block address of write data is added as an offset. Then, even if writing is completed within the segment of the cache memory, the remaining regions of the segment is not wasted.

### CROSS-REFERENCE TO RELATED APPLICATIONS

This application is based upon and claims the benefit of priority from Japanese Patent Application No. 2009-171373, filed Jul. 22, 2009, the entire contents of which are incorporated herein by reference.

### FIELD

Embodiments described herein relate generally to a cache memory control method, and an information storage device comprising a cache memory.

### BACKGROUND

Various information storage devices are developed, such as a magnetic disk device (hard disk drive: HDD) comprising a cache memory to increase access speed. The cache memory is a high-speed buffer for temporarily retaining data input/output between a host computer or the like and the information storage device. Part of a copy of data on the information storage device is stored in the cache memory. As this cache memory, a high-speed semiconductor memory such as a static RAM (SRAM) or a dynamic RAM (DRAM) is generally used.

Recently, high-capacity HDDs have been increasingly supplied at low cost, and HDDs in the several hundred gigabyte class or the terabyte class are used in, for example, AV personal computers, digital televisions and digital video recorders. A relatively high-capacity cache memory is used in such a high-capacity HDD.

Various improvements have been proposed for write control of the cache memory. In one example, a write cache is divided into n cache blocks, and cache directories are provided for the respective blocks, and each of the directories is provided with a disk address recording section, an offset information recording section and a data length recording section (see Jpn. Pat. Appin. KOKAI Publication No. 5-314008). Here, the offset information recording section indicates the distance from a head address on a disk (recording medium) to an address on the disk where valid data is to be written. When data in the cache block is stored in the disk, writing is started at an address away from an address indicated by the disk address recording section as far as the number of sectors indicated by the offset information recording section, and writing operation is continued as long as the number of sectors indicated by the data length recording section.

In another example, a cache memory is divided into N cells, and data to be read from or written into a disk is written into the cache memory from a position corresponding to the remainder obtained when an address on the disk is divided by a predetermined value N (see Jpn. Pat. Appin. KOKAI Publication No. 2003-330796).

In the information storage device comprising the cache memory, a write command and data are once written (write cache) into the cache memory when a write access request is issued to the information storage device from the host computer or the like. In this case, simply, the write command and the data have only to be continuously written into the cache memory (by simply incrementing the address of the cache memory). However, in such a simple method, a huge cache memory needs to be managed sector by sector, so that the amount of decoding is increased, and the management is extremely complicated.

There are methods of decreasing the amount of decoding, wherein a cache memory is managed by dividing the cache memory into particular units (segments such as blocks or cells) (Jpn. Pat. Appin. KOKAI Publication No. 5-314008 or Jpn. Pat. Appin. KOKAI Publication No. 2003-330796). For example, given that one sector has 512 bytes and the unit of a segment is 4 kilobytes (4 kB), the unit of one segment allows for eight sectors, so that the amount of decoding is ⅛. However, even in this case, address information (e.g., the head position and length of information to be written) has to be retained per write command. Moreover, if writing is performed starting from the head of the segment, remaining parts of the segment result in unusable wasteful regions in the case where the writing is completed in the middle of the segment.

### BRIEF DESCRIPTION OF THE DRAWINGS

FIG. 1 is an exemplary diagram showing an example of the configuration of a cache memory unit according to one embodiment of the invention;

FIG. 2 is an exemplary flowchart illustrating one example of a cache memory control method according to one embodiment of the invention;

FIG. 3 is an exemplary diagram illustrating an example of example of how a cache memory is used in the case where the invention is put into practice;

FIG. 4 is an exemplary diagram illustrating an example of how the cache memory is used in the case where the invention is not put into practice;

FIG. 5 is an exemplary diagram illustrating an information storage device or the like comprising the cache memory unit according to one embodiment of the invention; and

FIG. 6 is an exemplary diagram illustrating one example of information stored in a segment management table.

### DETAILED DESCRIPTION

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents. In the following description the term “unit” is used to have meaning of a “unit or module”.

In general, according to one embodiment of a cache memory control method of the invention, a data write position in a segment of a cache memory is changed to an address to which a lower bit of a logical block address (LBA) of write data is added as an offset, in order to solve the problem of the remaining parts of the segment turning into wasteful regions.

When the invention is put into practice, the segments of the cache memory can be used without waste. That is, the problem of the remaining parts of the segment turning into wasteful regions can be solved in the case where the writing is completed in the middle of the segment of the cache memory.

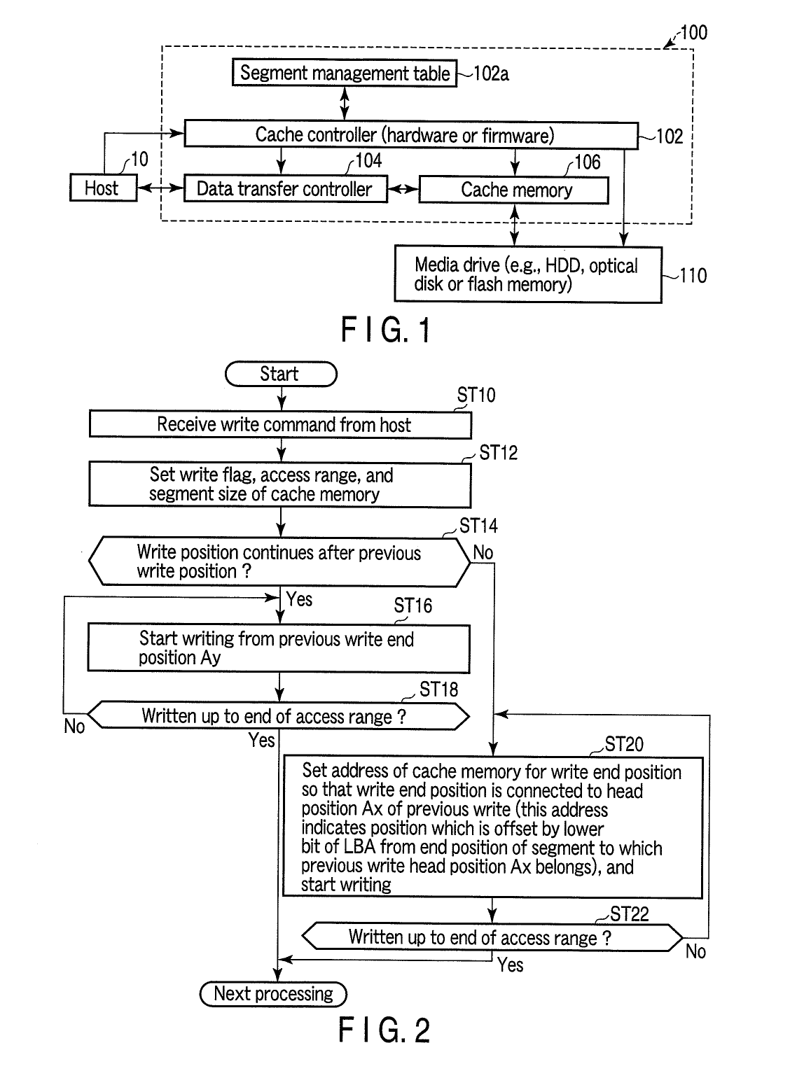

Various embodiments of the invention will hereinafter be described with reference to the drawings. FIG. 1 is an exemplary diagram showing an example of the configuration of a cache memory unit 100 according to one embodiment of the invention. Here, a media drive 110 that uses an HDD, an optical disk or a flash memory is illustrated as a high-capacity storage medium that uses a cache memory. Moreover, a host computer 10 is illustrated here as a source instrument for sending write data to the media drive 110 or as a sink instrument for receiving read data from the media drive 110.

The operation of reading from or writing into the media drive 110 is performed via the cache memory unit 100. In response to an instruction from the host computer 10, the cache memory unit 100 writes the write data from the host computer 10 into the media drive 110, or transfers the read data from the media drive 110 to the host computer 10.

Specifically, the cache memory unit 100 comprises a cache memory 106, a data transfer controller 104 for transferring the write data from the host computer 10 to the cache memory 106 or transferring the read data from the cache memory 106 to the host computer 10, and a cache controller 102 for controlling the operation of the data transfer controller 104 and the operation of the cache memory 106. Here, a storage area of the cache memory 106 is divided into a plurality of segments of a predetermined size, and a segment management table 102a into which information for managing the segments is written is connected to the cache controller 102.

In response to an instruction (e.g., a write command or a read command) from the host computer 10, the cache controller 102 performs control to write the write data from the host computer 10 into the media drive 110, or performs control to send the read data from the media drive 110 back to the host computer 10. In this case, if the cache memory 106 has the same data as the data stored in the media drive 110 to be read by the host computer 10 (cache hit), a copy of the data to be read is transferred from the cache memory 106 to the host computer 10 at high speed. The function of the cache controller 102 is obtained by a firmware that uses a hardware logic circuit or a microcomputer.

Here, high-speed processing can be easily performed when the cache controller 102 is configured by the hardware logic circuit. On the other hand, when the cache controller 102 is embodied by the firmware, the speed of processing is lower than in the case of the hardware logic circuit, but the contents of cache control processing are more easily changed.

In summary, the unit in FIG. 1 is an information storage device. This device comprises the cache memory 106 to be divided into segments of a predetermined size, the data transfer controller 104 for transferring the write data from the external (host 10) to the cache memory 106, the segment management table 102a for storing position information (see SA and EA in FIG. 6) for the segment in the cache memory 106 and offset position information (LBA lower bit) for the write data in the segments, the cache controller 102 for performing control to write the write data into the cache memory 106 by using a lower address of the logical block address (LBA) of the previous write data, and the data storage module 110 for storing information containing data written in the cache memory 106.

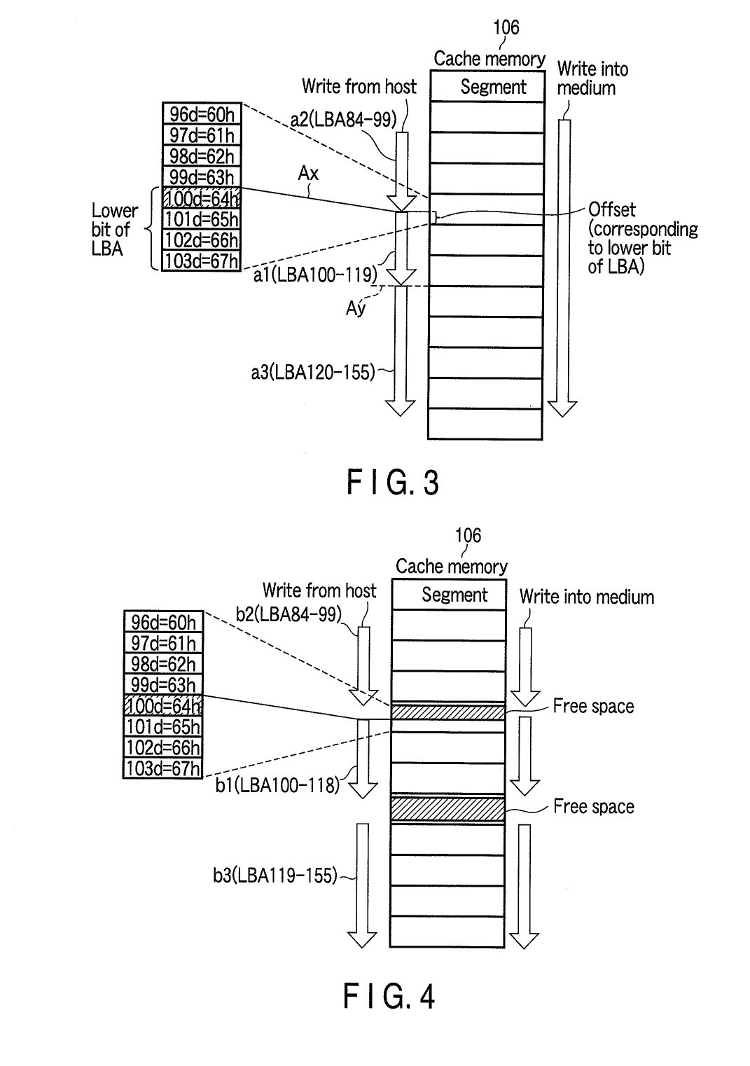

When the write data is written into the cache memory 106 divided in the predetermined size (e.g., 1 kB, 2 kB, 4 kB, 8 kB, 16 kB, 32 kB, 64 kB, 128 kB or 256 kB), the cache controller 102 in FIG. 1 performs processing, for example, as shown in FIG. 2. FIG. 2 is an exemplary flowchart illustrating one example of a cache memory control method according to one embodiment of the invention. FIG. 3 is an exemplary diagram illustrating an example of how the cache memory is used in the case where the invention is put into practice. Further, FIG. 6 is an exemplary diagram illustrating one example of information stored in the segment management table 102a.

When recording information in the media drive 110, the host computer 10 in FIG. 1 sends, to the cache controller 102, a write command including the address (logical block address LBA) and length of the write data. On receipt of the write command from the host computer 10 (ST10 in FIG. 2), the cache controller 102 determines one or more segments to be used to write the write data.

At the time of this determination, if there is a unused segment (segment in which no data is written) in the cache memory 106, this unused segment is first used to write the write data. When there is no unused segment in the cache memory 106, one or more segments having old write data are used in chronological order (or in ascending order of the number of cache hits during reading). If there are initially unused segments in the cache memory 106 but there remain no more unused segments during cache write, then one or more segments having old write data are used in chronological order (or in ascending order of the number of cache hits).

In addition, instead of simply using the segments having old write data first, the priorities of the segments to be used can be weighted in the cache controller 102 from the beginning.

When one or more segments to be used to write the write data are determined, write flags are set in these segments, and a write start address SA and a write end address EA (corresponding to the access range of the write data) are set, and then a segment size corresponding to the write data is set (ST12). Set information corresponding to these settings is stored in the segment management table 102a as illustrated in FIG. 6.

For example, 2 kB to 16 kB are set as segment sizes if the write data is text data or static image data, or 16 kB to 64 kB are set as segment sizes if the write data is moving image data. Moreover, 500 segments are used if, for example, the segment size is 16 kB and 8 MB of write data is to be cached.

In addition, information on the kind of write data (text data, static image data or moving image data) and/or on the bit rate of the write data (e.g., 2.2 Mbps, 4.6 Mbps, 16 Mbps or 24 Mbps in the case of the moving image data) can be included in the command sent from the host computer 10 to the cache controller 102.

Furthermore, offset data (see FIG. 3) that uses the lower bit of the LBA of the write data is properly set depending on the writing condition of the segments of the cache memory 106 or depending on which part of the cache memory the head or end of the write data is written in. This offset data can also be set for any segment as illustrated in FIG. 6, and the result of this setting is stored in the segment management table 102a in FIG. 1.

Although not shown, setting information for each segment to be stored in the segment management table 102a can properly include a flag for indicating whether data has been written in the segment, a flag for indicating whether the segment has any free space, a time stamp indicating the time when data has been written into the segment last, and information on, for example, the number of cache hits in reading of the data written in the segment.

When the setting of information in ST12 is finished for one or more segments to be used to write the write data, whether the current writing position of the write data continues after the previous writing is checked (ST14). For example, in FIG. 3, if a write a3 (its logical block addresses are, e.g., LBA 120 to 155) is generated in a part that continues after a previous write a1 (its logical block addresses are, e.g., LBA 100 to 119) (ST14 YES), the next writing is started from a part (cache memory address Ay) immediately after the previous write a1(ST16). After this writing is completed up to the end (LBA 155) of the access range (ST18 YES), the next processing follows.

On the other hand, in FIG. 3, if a write a2 is generated in a part (LBA 84 to 99) that continues before the data in LBA 100 to 119 written in the previous write a1 (ST14 NO), writing is started so that an address Ax of the cache memory to store the last data (data of LBA 99) of this write a2is connected to the head of the write a1 (ST20). After this writing is completed up to the end (LBA 99) of the access range (ST22 YES), the next processing follows.

Here, the position of the address Ax in the cache memory 106 is offset from the end of the segment to which the data end at the head of the write a1belongs. The lower bit of the LBA of the head data of the write a1 is used to indicate the offset position (see FIG. 3). Further, the lower bit of the LBA indicating the offset position is set in the segment management table 102a (e.g., a table for a segment n in FIG. 6) to which the head data (LBA 100) of the write a1belongs. That is, the offset amount of the data end in the segment can be known by referring to the segment management table 102a, so that the position of the address Ax in the cache memory 106 can be immediately determined.

FIG. 4 is an exemplary diagram illustrating an example of how the cache memory is used in the case where the invention is not put into practice. In the processing in FIG. 2, writing is performed so that no free space may be produced in the cache memory (FIG. 3) even if a new cache write is generated before or after the cache data provided by the previous write a1. In this case, if the data end of the previous write is located in the middle of the segment, a wasteful free space may be generated between the data end of the previous write b1and the data end of a new write b2 or b3, for example, as illustrated in FIG. 4, without any processing as in FIG. 2. When a great number of such free spaces are generated in various parts of the cache memory 106, the capacity of the cache memory 106 is substantially decreased. However, the processing as in FIG. 2 (ST20 in which offset information is created to cancel the free space by lower bit of the LBA of the write data) can prevent the generation of such a wasteful free space.

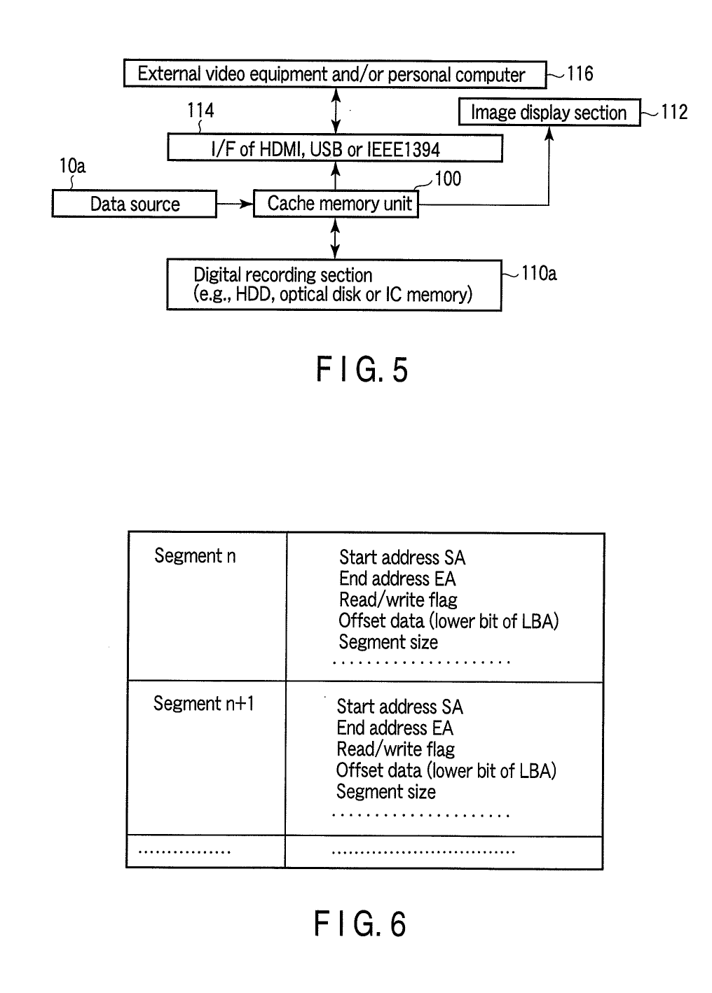

FIG. 5 is an exemplary diagram illustrating an information storage device or the like comprising the cache memory unit according to one embodiment of the invention. Write data (e.g., an MPEG-2 transport stream) sent from a data source 10a of, for example, a digital television tuner is recorded in a digital recording section 110a via the cache memory unit 100 having the configuration as in FIG. 1. The digital recording section 110a can be configured by a high-capacity HDD, an optical disk or an IC memory (flash memory). Reproduction data from the digital recording section 110a is sent to an image display section 112 via the cache memory unit 100, and properly decoded for image display. The reproduction data from the digital recording section 110a is also sent to external video equipment such as a digital video recorder and/or an AV personal computer 116 via a digital interface such as an HDMI, USB or IEEE1394.

The device in FIG. 5 is an information storage device (e.g., a television equipped with an HDD recorder, or an AV laptop computer). This device comprises the cache memory 100 which temporarily stores part of write data from the data source (e.g., a digital television tuner) 10a and which is to be divided into segments of a predetermined size, the data storage module 110a into which the write data is written via the cache memory 100 and from which the data written via the cache memory 100 is read, and the display module 112 which displays the data read from the data storage module 110a via the cache memory 100.

Otherwise, the device in FIG. 5 can also be said to be an information storage device (e.g., a DVD/BD recorder equipped with an HDD, or an AV personal computer). This device comprises the cache memory 100 which temporarily stores part of write data from the data source (e.g., a digital television tuner) 10a and which is to be divided into segments of a predetermined size, the data storage module 110a into which the write data is written via the cache memory 100 and from which the data written via the cache memory 100 is read, and an interface (e.g., an HDMI, USB or IEEE1394) 114 which externally outputs the data read from the data storage module 110a via the cache memory 100.

Here, the device in FIG. 5 is characterized in that the lower address of the logical block address LBA of the write data is used as an address offset in the segment when the write data is written into the cache memory 100 (ST20 in FIG. 2).

### SUMMARY OF THE EMBODIMENT

(01) For example, in the illustration in FIG. 3, when the new write (overwrite) a2 of data is generated in the part LBA 84 to 99 that continues before the data in LBA 100 to 119 written in the previous write a1, the address Ax of the cache memory 106 to store the last data (data of LBA 99) of this write a2 is located to be connected to the head of the write a1. The position of the address Ax in the cache memory 106 is offset from the end of the segment to which the head of the write a1 belongs. The lower bit of the LBA 100 of the head data of the write a1 is used to indicate the offset position.

(02) In the illustration in FIG. 3, when the new write a3 (LBA 120 to 155) is generated in the part that continues after the previous write a1 (LBA 100 to 119), the next writing (overwriting in the case where there is existing data after the address Ay) is started from the part (cache memory address Ay) immediately after the previous write a1.

### EFFECTS OF THE EMBODIMENT

(11) In the cache memory 106, when a write command is issued to a part before or after the LBA at which data has already been written, any segment in the cache memory 106 can be used without leaving a space, thus waste of cache areas can be eliminated. In other words, if a write is generated in an area that connects with the currently registered LBA, the new write is located to continue on the cache, so that wasteful regions can be reduced or removed. Moreover, continuous data in the LBA can be continuously arranged within the cache memory.

(12) Furthermore, link information (not shown) needed when cache data is scattered in the cache memory 106 can be put together, so that the amount of information needed in cache management can be reduced. That is, the cache memory can be easily managed, and at the same time, can be efficiently used without waste.

EXAMPLE OF CORRESPONDENCE BETWEEN EMBODIMENT AND INVENTION

(a) In the method of controlling the cache memory 106 divided into segments of a predetermined size, the lower address of the logical block address (LBA) of the write data is used as an address offset in the segment when the write data from the host 10 is written into the cache memory (ST20). That is, the cache memory is managed in particular units (segments), and when the write data from the host is written into the cache, the lower address of the LBA is used as an offset address in the segment.

(b) When a write is generated in a part before the logical block address (LBA) where data has been previously written (ST14 NO), data that is about to be written is arranged in the cache memory so that the end of this data is located immediately before the previously written data (ST20). That is, if a write is generated in a part before the LBA where data has been previously written, data that is about to be written is arranged in the cache memory so that the end of this data is located immediately before the previously written data. In this case, since the LBA is used as the offset address, the data that is about to be written is arranged without waste so that no free space is produced in the segment.

(c) When a write is generated in a part after the logical block address (LBA) where data has been previously written (ST14 YES), data that is about to be written is arranged in the cache memory so that the head of this data is located immediately after the previously written data (ST16). That is, if a write is generated in a part after the LBA where data has been previously written, data that is about to be written is arranged in the cache memory so that the head of this data is located immediately after the previously written data. In this case as well, the data that is about to be written is arranged without waste so that no free space is produced in the segment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of controlling a cache memory comprising segments of a predetermined size, the method comprising:
using a lower address of a logical block address of data as an address offset in the segment when the data is written into the cache memory.

2. The method of claim 1, wherein current data to be written is stored in the cache memory if a start address of the current data to be written is before a logical block address where data is already written, in such a manner that an end of the current data is located just before the written data.

3. The method of claim 1, wherein current data to be written is stored in the cache memory if a start address of the current data to be written is after a logical block address where data is already written, in such a manner that a head of the current data is located just after the written data.

4. The method of claim 1, wherein the predetermined size of the segment is set in accordance with a type of the data.

5. An information storage device comprising:
a cache memory comprising segments of a predetermined size;
a data transfer module configured to transfer external data to the cache memory;
a segment management module configured to store position information for the segments in the cache memory and offset position information for the external data in the segments;
a cache controller configured to use a lower address of a logical block address of the external data as the offset position information and to control the external data to be written into the cache memory; and
a data storage module configured to store information comprising the data written in the cache memory.

6. An information storage device comprising:
a cache memory comprising segments of a predetermined size, configured to temporarily store a portion of data from a data source;
a data storage module configured to store the data via the cache memory; and
a display module configured to display the data from the data storage module via the cache memory,
wherein a lower address of a logical block address of the data is used as an address offset in the segment when the data is written into the cache memory.

7. An information storage device comprising:
a cache memory comprising segments of a predetermined size, configured to temporarily store a portion of data from a data source;
a data storage module configured to store the data via the cache memory; and an interface configured to output the data from the data storage module via the cache memory,
wherein a lower address of a logical block address of the data is used as an address offset in the segment when the data is written into the cache memory.
